(19) United States
(12) Patent Application Publication
(10) Pub. No.: US 2019/0027107 A1
(43) Pub. Date: Jan. 24, 2019

(54) Driving Method of Liquid Crystal Display Panel

(71) Applicant: Shenzhen China Star Optoelectronics Semiconductor Display Technology Co., Ltd., Shenzhen, Guangdong (CN)

(72) Inventor: Xianming Zhang, Shenzhen (CN)

(73) Assignee: Shenzhen China Star Optoelectronics Semiconductor Display Technology Co., Ltd., Shenzhen, Guangdong (CN)

(21) Appl. No.: 15/575,233

(22) PCT Filed: Sep. 11, 2017
(86) PCT No.: PCT/CN2017/101191

§ 371 Date: Nov. 17, 2017

(30) Foreign Application Priority Data
Jul. 20, 2017 (CN) 201710594868.2

(51) Int. Cl. G09G 3/36; G09G 3/34

(52) U.S. Cl. CPC G09G 3/3611; G09G 3/3406; G09G 2330/021; G09G 2310/08; G09G 2320/0252; G09G 2320/0646

(57) ABSTRACT

A driving method of a liquid crystal display panel is provided. The driving method has steps of capturing all image frames of a display image content, wherein each of the image frames includes a charging sub image frame and a displaying sub image frame; and driving all image frames of the display image content sequentially. A driving step of each of the image frames comprise steps of driving the charging sub image frame of all image frames and turning of a backlight module, driving the displaying sub image frame, and turning on the backlight module.

### FIELD OF THE INVENTION

The present disclosure relates to a technical field of liquid crystal displays, and in particular to a driving method of a liquid crystal display panel.

### BACKGROUND OF THE INVENTION

With advances in technology, liquid crystal display panels are used in all areas of society. At same time, quality requirements for image display of the liquid crystal display panel are increasing.

Due to inherent characteristics of liquid crystals in a liquid crystal layer of the liquid crystal display panel, the liquid crystal molecules of the liquid crystal layer move for a period of time. Content of display images of the liquid crystal display panel is easily seen when the liquid crystal molecules move so that the image seems blurry. For dynamic images, the display image content changes quickly so that blurring will be more serious.

In current liquid crystal display panels, liquid crystal display panels are driven by over driving, which can decrease blurring of an image in a specific frame so that the blurring of the image can be reduced when displayed. However, the blurring of the image cannot be eliminated using the current driving method of the liquid crystal display panel.

As a result, it is necessary to provide a driving method of a liquid crystal display panel for solving the problems existing in conventional technologies.

### SUMMARY OF THE INVENTION

An object of the present disclosure is to provide a driving method of a liquid crystal display panel which solves the problem that blurring of an image cannot be eliminated by adopting a current driving method of a liquid crystal display panel.

To achieve the above objects, the present disclosure provides a driving method of a liquid crystal display panel, which comprises steps of: capturing all image frames of a display image content, wherein each of the image frames includes a charging sub image frame and a displaying sub image frame; and driving all image frames of the display image content sequentially. The driving step of each of the image frames comprises steps of: driving the charging sub image frame of all image frames, and informing a backlight module to synchronously turn off through serial peripheral interface protocol; and driving the displaying sub image frame of all image frames, and informing the backlight module to synchronously turn on through the serial peripheral interface protocol. A dimming operation of pulse width modulation is implemented for the backlight module when the backlight module is turned on.

In the driving method of the liquid crystal display panel of the present disclosure, a data signal inputted into a pixel unit of the liquid crystal display panel at driving the charging sub image frame of the image frame and a data signal inputted into the pixel unit of the liquid crystal display panel at driving the displaying sub image frame of the image frame are same.

In the driving method of the liquid crystal display panel of the present disclosure, a corresponding data signal is inputted into a pixel unit of the liquid crystal display panel at driving the charging sub image frame of the image frame; and a data signal is not inputted into the pixel unit of the liquid crystal display panel at driving the displaying sub image frame of the image frame.

In the driving method of the liquid crystal display panel of the present disclosure, a driving time of a corresponding charging sub image frame of each of the image frames and a driving time of a corresponding displaying sub image frame of each of the image frames are same.

In the driving method of the liquid crystal display panel of the present disclosure, a display frequency of the image frame is 120 Hz.

In the driving method of the liquid crystal display panel of the present disclosure, a driving time of a corresponding charging sub image frame of each of the image frames is less than a driving time of a corresponding displaying sub image frame of each of the image frames.

In the driving method of the liquid crystal display panel of the present disclosure, a display frequency of the image frame is 120 Hz.

To achieve the above objects, the present disclosure provides a driving method of a liquid crystal display panel, which comprises steps of: capturing all image frames of display image content, wherein each of the image frames includes a charging sub image frame and a displaying sub image frame; and driving all image frames of display image content sequentially. Wherein driving step of each of the image frames comprises steps of: driving the charging sub image frame of all image frames, and turning off a corresponding backlight module; and driving the displaying sub image frame of all image frames, and turning on a corresponding backlight module.

In the driving method of the liquid crystal display panel of the present disclosure, a data signal inputted into a pixel unit of the liquid crystal display panel at driving the charging sub image frame of the image frame and a data signal inputted into a pixel unit of the liquid crystal display panel at driving the displaying sub image frame of the image frame are same.

In the driving method of the liquid crystal display panel of the present disclosure, a corresponding data signal is inputted into a pixel unit of the liquid crystal display panel at driving the charging sub image frame of the image frame; and a data signal is not inputted into a pixel unit of the liquid crystal display panel at driving the displaying sub image frame of the image frame.

In the driving method of the liquid crystal display panel of the present disclosure, a driving time of a corresponding charging sub image frame of each of the image frames and a driving time of a corresponding displaying sub image frame of each of the image frames are same.

In the driving method of the liquid crystal display panel of the present disclosure, a display frequency of the image frame is 120 Hz.

In the driving method of the liquid crystal display panel of the present disclosure, a driving time of a corresponding charging sub image frame of each of the image frames is less than a driving time of a corresponding displaying sub image frame of each of the image frames.

In the driving method of the liquid crystal display panel of the present disclosure, a display frequency of the image frame is 120 Hz.

In the driving method of the liquid crystal display panel of the present disclosure, a dimming operation of pulse width modulation is implemented for the backlight module when the backlight module is turned on.

In the driving method of the liquid crystal display panel of the present disclosure, the step of driving the charging sub image frame of all image frames, and turning off the corresponding backlight module is driving the charging sub image frame of all image frames, and informing the backlight module to synchronously turn off through serial peripheral interface protocol.

In the driving method of the liquid crystal display panel of the present disclosure, the step of driving the displaying sub image frame of all image frames, and turning on the corresponding backlight module is driving the displaying sub image frame of all image frames, and informing the backlight module to synchronously turn on through the serial peripheral interface protocol.

The driving method of the liquid crystal display panel of the present disclosure is provided for dividing the charging sub image frame and the displaying sub image frame, and the blurring of the image is effectively eliminated by turning off the backlight module in the charging sub image frame. Thus, the problem that the blurring of the image cannot be eliminated by adopting the current driving method of the liquid crystal display panel can be solved.

### DESCRIPTION OF THE DRAWINGS

In order to more clearly illustrate the embodiments or the prior art technical solutions embodiment of the present disclosure, will implement the following FIGURES for the cases described in the prior art or require the use of a simple introduction. Obviously, the following description of the drawings are only some of those of ordinary skill in terms of creative effort without precondition, you can also obtain other drawings based on these drawings embodiments of the present disclosure.

FIG. 1 is a flow chart of a preferred embodiment of a driving method of a liquid crystal display panel of the present disclosure.

### DETAILED DESCRIPTION OF PREFERRED EMBODIMENTS

Below, in conjunction with the accompanying drawings of the present disclosure in embodiments, the technical solutions in the embodiments of the present disclosure are clearly and completely described. Obviously, the described embodiments are part of the embodiments of the present disclosure rather than all embodiments. Based on the embodiments of the present disclosure, those of ordinary skill in the art to make all other embodiments without creative work obtained by, it falls within the scope of the present disclosure.

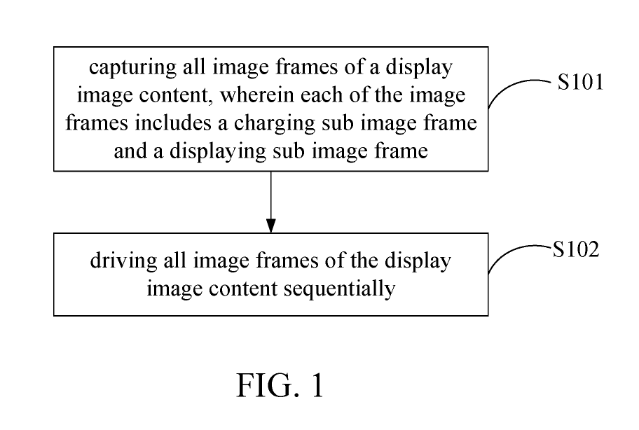

Referring to FIG. 1, a flowchart of a preferred embodiment of a driving method of a liquid crystal display panel of the present disclosure is shown. The driving method of a liquid crystal display panel of the present disclosure comprises:

Step S101: capturing all image frames of display image content, wherein each of the image frames includes a charging sub image frame and a displaying sub image frame.

Step S102: driving all image frames of the display image content sequentially.

The specific process of each of the steps in the driving method of a liquid crystal display panel of the present disclosure are described in detail below.

In the step S101, the liquid crystal display panel captures all image frames of a display image content, wherein each of the image frames includes a charging sub image frame and a displaying sub image frame.

The charging sub image frame is a sub image frame for charging data signals to a pixel unit of the liquid crystal display panel. In the charging sub image frame, liquid crystal molecules of the liquid crystal layer can move. If a user watches the display image content from the charging sub image frame, he will see blurring of the image.

The displaying sub image frame is a sub image frame that the pixel unit of the liquid crystal display panel displays stably. In the displaying sub image frame, the liquid crystal molecules of the liquid crystal layer stably move. If a user watches the display image content from the displaying sub image frame, the blurring of the image does not appear. The flow moves to step S102.

In the step S102, the liquid crystal display panel sequentially drives all image frames of the display image content captured from the step S101, wherein driving step of each of the image frames comprise steps of:

First the liquid crystal display panel drives the charging sub image frame of all image frames, and turns off the corresponding backlight module so that the liquid crystal molecules of the liquid crystal layer are driven to move. At this time, a user cannot watch the corresponding display image content. Thus, the blurring of the image does not appear.

When the liquid crystal display panel drives the charging sub image frame of the image frames, the liquid crystal display panel can inform the backlight module to synchronously turn off through serial peripheral interface (SPI) protocol for increasing the synchronization of turning off the charging sub image frame and the backlight module.

Then the liquid crystal display panel drives the displaying sub image frame of the image frames, and synchronously turns on the backlight module. The liquid crystal molecules of the liquid crystal layer in the charging sub image frame have moveed. At this time, user can watch the corresponding display image content. Thus, the blurring of the image does not appear.

When the liquid crystal display panel drives the displaying sub image frame of the image frames, the liquid crystal display panel can inform the backlight module to synchronously turn on through serial peripheral interface (SPI) protocol for increasing the synchronization of turning on the charging sub image frame and the backlight module.

When the backlight module is turned on, the liquid crystal display can process a dimming operation of pulse width modulation (PWM) to the backlight module for adjusting a display image brightness of image frames.

It can be set that a corresponding data signal is inputted into a pixel unit of the liquid crystal display panel at driving the charging sub image frame of the image frame, and a data signal is not inputted into the pixel unit of the liquid crystal display panel at driving the displaying sub image frame of the image frame. At driving the displaying sub image frame, the pixel unit keeps the current data signal, and it can ensure to display the display image content corresponding to the image frames. Thus, the energy consumption of the liquid crystal display can be reduced effectively.

For ensuring the stability of the display image content of the displaying sub image frame, it can be set that a data signal inputted into the pixel unit of the liquid crystal display panel at driving the charging sub image frame of the image frame and a data signal inputted into the pixel unit of the liquid crystal display panel at driving the displaying sub image frame of the image frame are same. Thus, it can be avoided that the leakage current of the pixel unit affects the display image content of the displaying sub image frame.

Wherein, a display frequency of the image frame is 120 Hz. For example, a driving time of a corresponding charging sub image frame of each of the image frames is same as a driving time of a corresponding displaying sub image frame of each of the image frames, and a display frequency of a sub image frame (charging sub image frame and displaying sub image frame) of the liquid crystal display panel is 240 Hz. It is convenient to set up the charging sub image frame and the displaying sub image frame for the user.

For increasing display of the liquid crystal display panel, a driving time of a corresponding charging sub image frame of each of the image frames is less than a driving time of a corresponding displaying sub image frame of each of the image frames. In the charging sub image frame, the liquid crystal molecules of the liquid crystal layer moves by spending a short time. In the displaying charging sub image frame, the display image content of the image frame displays by spending a long time. Thus, the operating time of the backlight module can be improved, and the display image brightness of image frames can be increased, and the backlight power consumption of the backlight module corresponding the liquid crystal display can be reduced.

Therefore, a drive process of the image frames in the driving method of the liquid crystal display panel of the present disclosure can be finished.

The driving method of the liquid crystal display panel of the present disclosure is provided for dividing the charging sub image frame and the displaying sub image frame, and the blurring of the image is effectively eliminated by turning off the backlight module in the charging sub image frame. Thus, the problem that the blurring of the image cannot be eliminated by adopting the current driving method of the liquid crystal display panel can be solved.

In summary, although the preferred embodiment of the present disclosure is disclosed above, but the above-described preferred embodiments are not intended to limit the disclosure, those of ordinary skill in the art, without departing from the spirit and scope of the present disclosure, can make various kinds of alterations and modifications, and the scope of the disclosure is defined by the scope of claims.

What is claimed is:

1. A driving method of a liquid crystal display panel, comprising steps of:
capturing all image frames of a display image content, wherein each of the image frames includes a charging sub image frame and a displaying sub image frame; and
driving all image frames of the display image content sequentially;
wherein a driving step of each of the image frames comprise steps of:
driving the charging sub image frame of all image frames, and informing a backlight module to synchronously turn off through a serial peripheral interface protocol; and
driving the displaying sub image frame of all image frames, and informing the backlight module to synchronously turn on through the serial peripheral interface protocol;
wherein a dimming operation of pulse width modulation is implemented for the backlight module when the backlight module is turned on.

2. The driving method of the liquid crystal display panel according to claim 1, wherein a data signal inputted into a pixel unit of the liquid crystal display panel at driving the charging sub image frame of the image frame and a data signal inputted into the pixel unit of the liquid crystal display panel when driving the displaying sub image frame of the image frame are same.

3. The driving method of the liquid crystal display panel according to claim 1, wherein a corresponding data signal is inputted into a pixel unit of the liquid crystal display panel at driving the charging sub image frame of the image frame; and a data signal is not inputted into the pixel unit of the liquid crystal display panel at driving the displaying sub image frame of the image frame.

4. The driving method of the liquid crystal display panel according to claim 1, wherein a driving time of a corresponding charging sub image frame of each of the image frames and a driving time of a corresponding displaying sub image frame of each of the image frames are same.

5. The driving method of the liquid crystal display panel according to claim 4, wherein a display frequency of the image frame is 120 Hz.

6. The driving method of the liquid crystal display panel according to claim 1, wherein a driving time of a corresponding charging sub image frame of each of the image frames is less than a driving time of a corresponding displaying sub image frame of each of the image frames.

7. The driving method of the liquid crystal display panel according to claim 6, wherein a display frequency of the image frame is 120 Hz.

8. A driving method of a liquid crystal display panel, comprising steps of:
capturing all image frames of display image content, wherein each of the image frames includes a charging sub image frame and a displaying sub image frame; and
driving all image frames of display image content sequentially;
wherein a driving step of each of the image frames comprises steps of:
driving the charging sub image frame of all image frames, and turning off a backlight module; and
driving the displaying sub image frame of all image frames, and turning on a backlight module.

9. The driving method of the liquid crystal display panel according to claim 8, wherein a data signal inputted into a pixel unit of the liquid crystal display panel at driving the charging sub image frame of the image frame and a data signal inputted into a pixel unit of the liquid crystal display panel at driving the displaying sub image frame of the image frame are same.

10. The driving method of the liquid crystal display panel according to claim 8, wherein a corresponding data signal is inputted into a pixel unit of the liquid crystal display panel at driving the charging sub image frame of the image frame; and a data signal is not inputted into a pixel unit of the liquid crystal display panel at driving the displaying sub image frame of the image frame.

11. The driving method of the liquid crystal display panel according to claim 8, wherein a driving time of a corresponding charging sub image frame of each of the image frames and a driving time of a corresponding displaying sub image frame of each of the image frames are same.

12. The driving method of the liquid crystal display panel according to claim 11, wherein a display frequency of the image frame is 120 Hz.

13. The driving method of the liquid crystal display panel according to claim 8, wherein a driving time of a corresponding charging sub image frame of each of the image frames is less than a driving time of a corresponding displaying sub image frame of each of the image frames.

14. The driving method of the liquid crystal display panel according to claim 13, wherein a display frequency of the image frame is 120 Hz.

15. The driving method of the liquid crystal display panel according to claim 8, a dimming operation of pulse width modulation is implemented for the backlight module when the backlight module is turned on.

16. The driving method of the liquid crystal display panel according to claim 8, the step of driving the charging sub image frame of all image frames, and turning off the corresponding backlight module is:
driving the charging sub image frame of all image frames, and informing the backlight module to synchronously turn off through serial peripheral interface protocol.

17. The driving method of the liquid crystal display panel according to claim 8, the step of driving the displaying sub image frame of all image frames, and turning on the corresponding backlight module is:
driving the displaying sub image frame of all image frames, and informing the backlight module to synchronously turn on through the serial peripheral interface protocol.
